(19) United States
(12) Patent Application Publication
(10) Pub. No.: US 2026/0335846 A1
(43) Pub. Date: Oct. 29, 2026

(54) GAS-LIQUID REACTION DEVICE

(71) Applicant: Industrial Technology Research Institute, Hsinchu (TW)

(72) Inventors: HAN-YU CHANG, Tainan City (TW); TING-YI WU, Tainan City (TW); WEI-CHIN HUANG, Tainan City (TW); FANG-CHENG LI, Kaohsiung City (TW); CHENG-CHI CHOU, Kaohsiung City (TW); CHI-WEN LIAO, Hsinchu County (TW)

(21) Appl. No.: 19/399,968

(22) Filed: Nov. 25, 2025

Related U.S. Application Data
(60) Provisional application No. 63/727,213, filed on Dec. 3, 2024.

(51) Int. Cl. B01F 25/314; B01F 25/431; B01F 25/434; B01F 33/82; B01F 101/00

(52) U.S. Cl. CPC B01F 25/3141; B01F 25/43171; B01F 25/43172; B01F 25/434; B01F 33/82; B01F 2101/2204; B01F 2215/0422

(57) ABSTRACT

A gas-liquid reaction device includes a first cavity, a second cavity disposed within the first cavity, a third cavity disposed within the second cavity, and at least one gas inlet pipe connected to the first cavity. The first space of the first cavity is connected to the external space, the first space is connected to the second space of the second cavity, and the second space is connected to the third space of the third cavity. The liquid enters the first cavity through the first open end of the first cavity. After the gas enters the first cavity through the gas inlet pipe, the liquid and gas are mixed in the first stage in the first cavity, flow into the second cavity for the second stage of mixing, flow into the third cavity for the third stage of mixing, and flow out of the third cavity.

### CROSS REFERENCE TO RELATED APPLICATION

The subject application claims the benefit of priority to U.S. Provisional Application No. 63/727,213, filed on Dec. 3, 2024, the entire disclosure of which is incorporated herein by reference.

### TECHNICAL FIELD

The present disclosure relates to a gas-liquid mixing reaction device, and in particular to a gas-liquid reaction device with continuous multi-stage mixing for the gas and liquid.

### BACKGROUND

Gas-liquid mixing reaction technology is widely used in various fields. After the gas and liquid are introduced into the reaction chamber to mix and react, a usable solid substance can be produced. If the gas and liquid can be fully and uniformly mixed, it will be more conducive to the production of usable substances.

Accordingly, developing a “gas-liquid reaction device” that enables continuous multi-stage mixing of gas and liquid, increases reaction rate, reduces reaction time, and has a small volume is an urgent problem to be solved by persons in related technical fields.

### SUMMARY

In one embodiment, the present disclosure provides a gas-liquid reaction device, comprising:
a first cavity, parallel to a central axis and having a first open end and a first closed end opposite to each other, and further having a first space, wherein the first space is connected to the first open end;
a second cavity, disposed within the first cavity but not in contact with the first cavity, wherein the second cavity has an opposite second closed end, a second open end, a plurality of second blades, a second space, an outer side wall, and a plurality of through grooves, each of the second blades is disposed on an outer side wall of the second cavity respectively and extends in an arc from the second closed end toward the second open end, an end of each of the second blades near the second closed end is a second blade entry end, an end of each of the second blades near the second open end is a second blade exit end, a second curved channel is formed between two adjacent second blades, each second curved channel is connected to the first open end, each of the through grooves is disposed through the outer side wall and extends from the second open end toward the second closed end and has a first end and a second end opposite to each other, the first end is located at the second open end, an extension direction of a line connecting the first end and the second end has a second included angle greater than 0 degrees and less than 90 degrees with the second open end, and the second space and the first space are connected by each of the through grooves;
a third cavity, disposed within the second cavity and not in contact with the second cavity, wherein the third cavity has a third entry end and a third exit end that are opposite to and connected to each other, and a third space, the third space is provided with a plurality of third blades, each of the third blades extends in an arc from the third entry end toward the third exit end, an end of each third blade near the third entry end is a third blade entry end, and an end of each third blade near the third exit end is a third blade exit end, a third curved channel is formed between two adjacent third blades, the second space and the third space are connected by each of the third curved channels; and
at least one gas inlet pipe, connected to the first cavity, wherein each gas inlet pipe is composed of a first tube, a connecting tube and a second tube that are connected to each other, an end of the first tube connected to the connecting tube is a gas inlet end, and an end of the second tube connected to the connecting tube is a gas outlet end, and the gas outlet end is connected to the first cavity so that each gas inlet pipe is connected to the first cavity;
when the central axis is perpendicular to a horizontal plane and a horizontal height of the first open end is higher than a horizontal height of the first closed end, a horizontal height of the second closed end is higher than a horizontal height of the second open end, a horizontal height of the third inlet end is higher than a horizontal height of the third outlet end, a projection position of the first end of each of the through grooves is misaligned with a projection position of the second end, and a projection range of the gas outlet end parallel to the horizontal plane is located within a projection range of each through groove parallel to the horizontal plane.

### BRIEF DESCRIPTION OF THE DRAWINGS

FIG. 1 is a three-dimensional appearance structural diagram of one embodiment of the present disclosure.

FIG. 2 is a top-view structural diagram of the embodiment in FIG. 1.

FIG. 3 is a bottom-view structural diagram of the embodiment in FIG. 1.

FIG. 4 is a cross-sectional structural diagram along line A-A in FIG. 2.

FIG. 5 is a cross-sectional structural diagram of the first cavity in the embodiment of FIG. 1.

FIG. 6 is a cross-sectional structural diagram of the second cavity in the embodiment of FIG. 1.

FIG. 7 is a three-dimensional appearance structural diagram of the second cavity in the embodiment of FIG. 1.

FIG. 7A is a schematic diagram of the relative relationship between the through groove and the central axis of the present disclosure.

FIG. 8 is a cross-sectional structural diagram along line B-B in FIG. 6.

FIG. 9 is a cross-sectional structural diagram of the third cavity in the embodiment of FIG. 1.

FIG. 10 is a three-dimensional appearance structural diagram of the third cavity in the embodiment of FIG. 1.

FIG. 10A is a top-view structural diagram of the embodiment in FIG. 10.

FIG. 10B is a bottom-view structural diagram of the embodiment in FIG. 10.

FIG. 11 is a cross-sectional structural diagram of the central axis when it is set perpendicular to the horizontal plane in the embodiment of FIG. 1.

FIG. 12 is a schematic diagram illustrating the flowing path of gas and liquid of the present disclosure.

### DETAILED DESCRIPTION

The features and exemplary embodiments of various aspects of the present disclosure will be described in detail. In order to make the purpose, technical solution and advantages of the present disclosure clearer, the disclosure will be further described in detail below with reference to the accompanying drawings and specific embodiments. It should be understood that the specific embodiments described herein are intended to merely explain the present disclosure and not to limit the present disclosure. The present disclosure can be implemented by those skilled in the art without requiring some of the details of these specific details. The following descriptions of the embodiments are merely intended to provide a better understanding of the present disclosure by illustrating examples of the present disclosure.

It should be noted that in this context, relational terms such as first and second are used only to distinguish one entity or operation from another entity or operation, and do not necessarily require or imply any such actual relationship or order between these entities or operations. Moreover, the terms “comprising,” “including,” or any other variations thereof are intended to cover non-exclusive inclusion, such that a process, method, article, or apparatus that comprises a list of elements includes not only those elements but also other elements not expressly listed, or elements inherent to such process, method, article, or apparatus. Without further restrictions, the element limited by the phrase “comprising . . . ” does not preclude the presence of other identical elements in a process, method, article, or apparatus that includes the element.

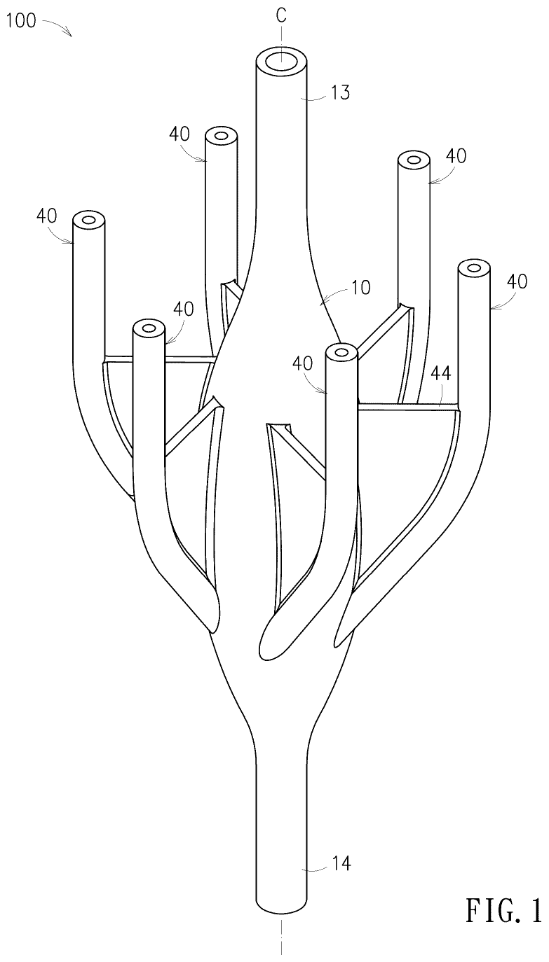

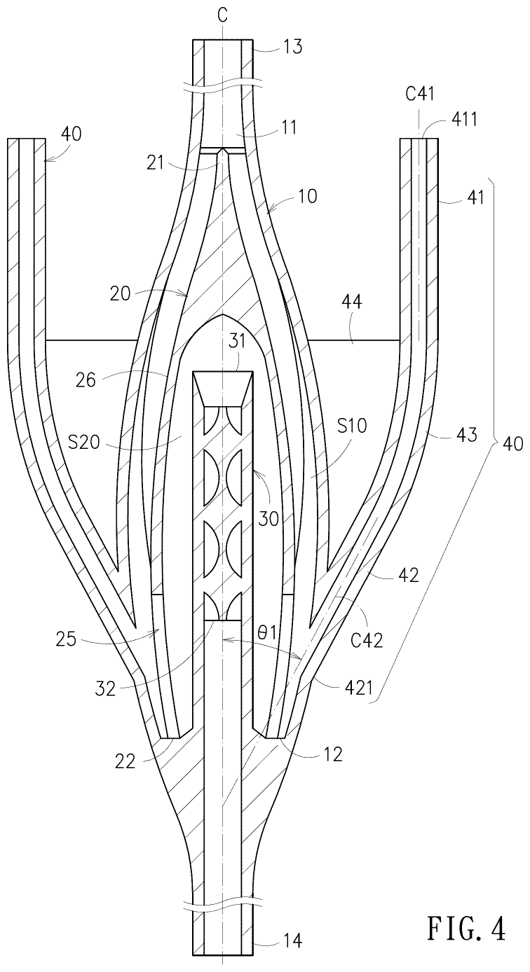

Please refer to the embodiment structure shown in FIGS. 1 and 4. The gas-liquid reaction device 100 of the present disclosure includes a first cavity 10, a second cavity 20, a third cavity 30, and six gas inlet pipes 40. In other embodiments, the number of gas inlet pipes 40 may be adjusted based on needs, and no limitation is made thereto.

Please refer to FIG. 4. The first cavity 10 is parallel to a central axis C and has a first open end 11 and a first closed end 12. The second cavity 20 is parallel to the central axis C and has a second closed end 21 and a second open end 22. The third cavity 30 is parallel to the central axis C, and it has a third entry end 31 and a third exit end 32 that are opposite to and connected to each other.

The central axis C passes through the center of the first open end 11 and the center of the first closed end 12, the center of the second closed end 21 and the center of the second open end 22, and the center of the third entry end 31 and the third exit end 32. That is, in this embodiment, the first cavity 10, the second cavity 20 and the third cavity 30 are coaxially arranged.

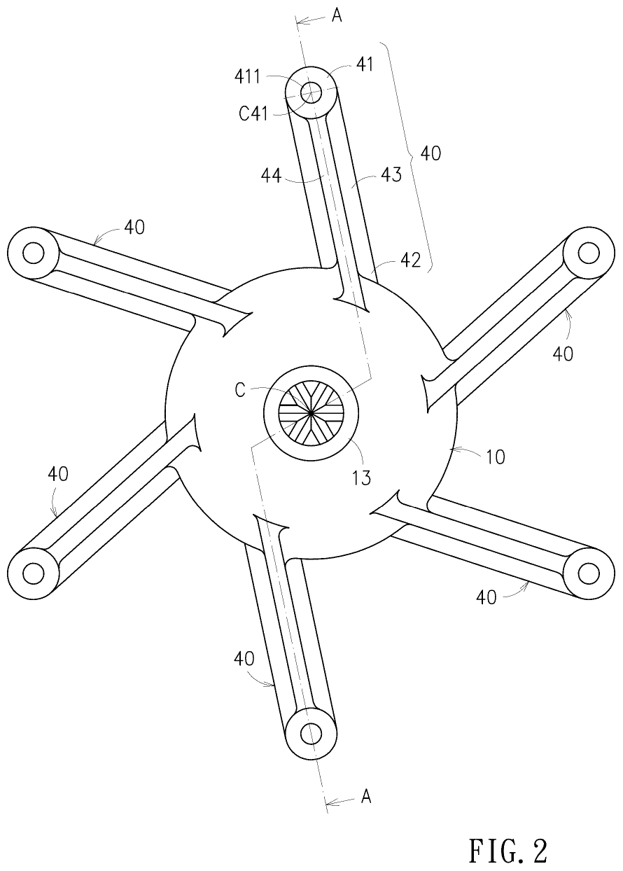

Please refer to FIGS. 2 to 4. The gas inlet pipes 40 are arranged equidistantly around the first cavity 10. The gas inlet pipe 40 is composed of a first tube 41, a second tube 42, and a connecting tube 43. The connecting tube 43 is disposed to be interconnected with the first tube 41 and the second tube 42 respectively. That is, the connecting tube 43 is disposed between the first tube 41 and the second tube 42.

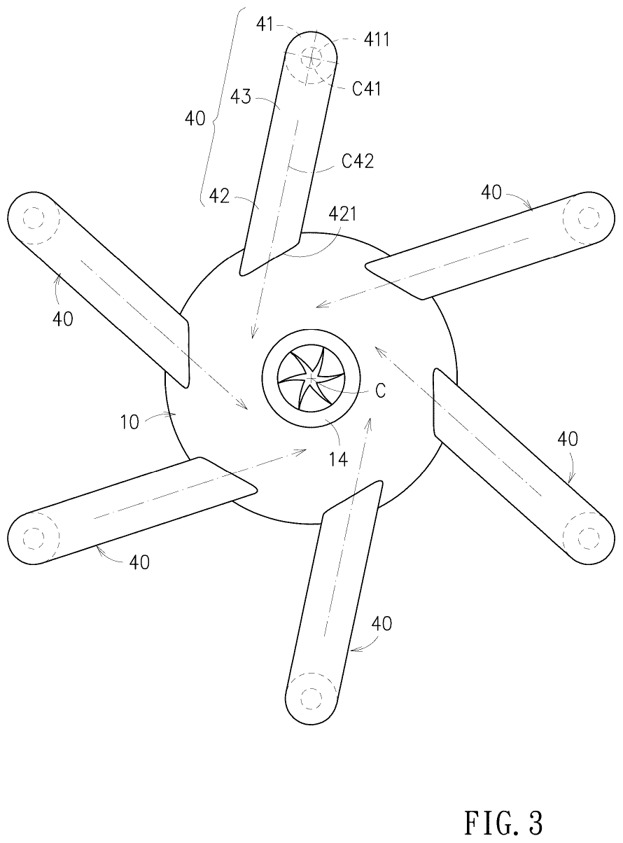

One end of the first tube 41 connected to the connecting tube 43 is a gas inlet end 411, and an end of the second tube 42 connected to the connecting tube 43 is a gas outlet end 421. The gas outlet end 421 is connected to the first cavity 10 so that each gas inlet pipe 40 is connected to the first cavity 10. As shown in FIG. 3, the axis center C42 of each second tube 42 is misaligned with the central axis C.

The connecting tube 43 is curved and bent.

As shown in FIG. 4, the axis center C41 of the first tube 41 is parallel to the central axis C, and the axis center C42 of the second tube 42 has a first included angle θ1 greater than 0 degrees and less than 90 degrees with the central axis C.

Each gas inlet pipe 40 is interconnected to the first cavity 10 by providing a connecting piece 44 therebetween. The connecting piece 44 is flat for supporting each gas inlet pipe 40 to prevent it from shaking during operation.

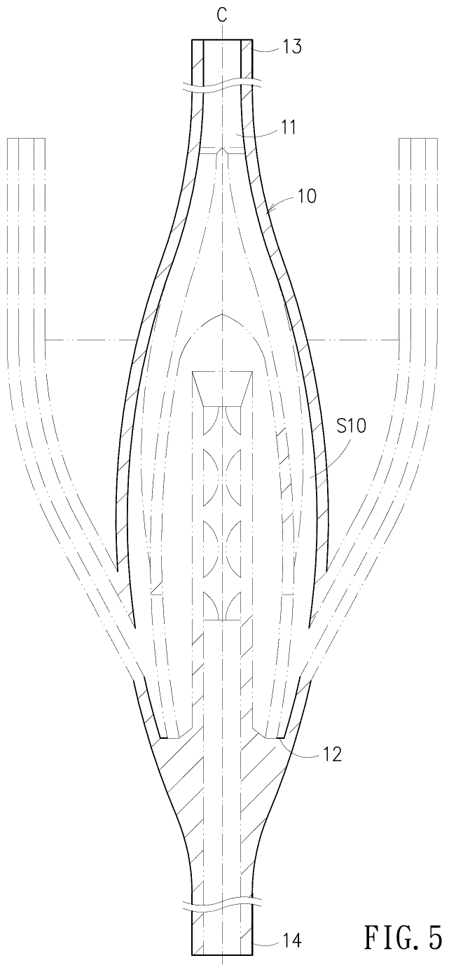

Please refer to FIGS. 1, 4 and 5. The first cavity 10 further includes a first space S10. The first cavity 10 extends parallel to the central axis C relatively to form a cylindrical liquid inlet pipe 13 and a cylindrical gas-liquid outlet pipe 14.

The inner diameter of the first cavity 10 gradually narrows toward the first open end 11 and the first closed end 12, so that the first space S10 of the first cavity 10 is a spindle-shaped internal space.

The liquid inlet pipe 13 is connected to the first open end 11. The first space S10 is connected to the external space outside the first cavity 10 through the first open end 11 and the liquid inlet pipe 13. The first closed end 12 is not directly connected to the external space.

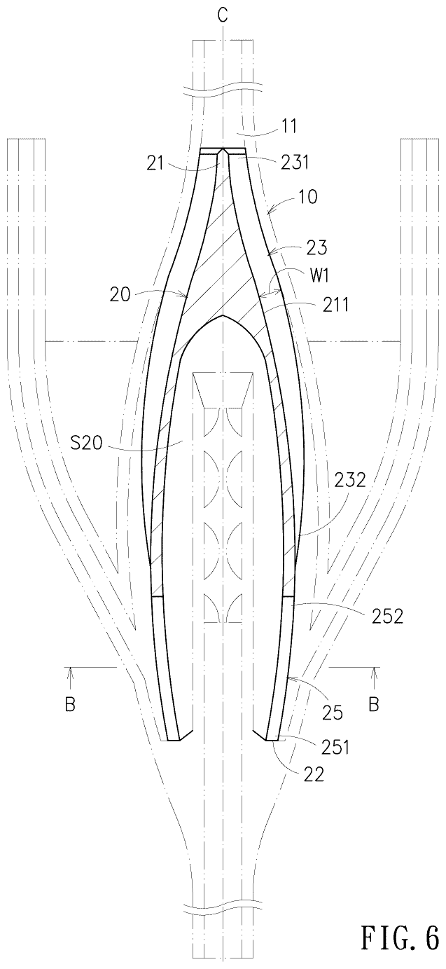

Please refer to FIGS. 4 and 6. The second cavity 20 is parallel to the central axis C and has a second closed end 21 and a second open end 22. The second cavity 20 further includes a second space S20, a plurality of second blades 23, a plurality of through grooves 25, and an outer side wall 26. The second cavity 20 is disposed inside the first cavity 10 and does not directly contact the first cavity 10. The outer side wall 26 surrounds and defines the second space S20.

The inner diameter of the second cavity 20 gradually narrows toward the second closed end 21 and the second open end 22, so that the second space S20 of the second cavity 20 is an elongated elliptical internal space.

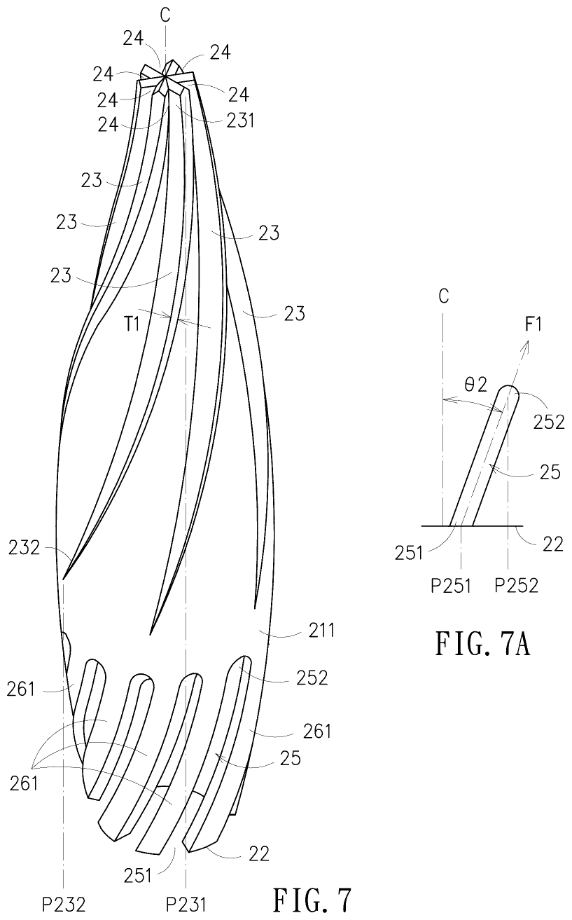

Please refer to FIGS. 6 and 7. The second blades 23 are arranged equidistantly around the outer side wall 26. A second curved channel 24 is formed between two adjacent second blades 23. Each of the second curved channels 24 is connected to the first open end 11.

Please refer to FIGS. 6 and 7. The second blade 23 extends in an arc from the second closed end 21 toward the second open end 22. The end of the second blade 23 near the second closed end 21 is the second blade entry end 231, and the end of the second blade 23 near the second open end 22 is the second blade exit end 232. When the central axis C is set perpendicular to the horizontal plane as shown in FIG. 7, the projection position P231 of the second blade entry end 231 is misaligned with the projection position P232 of the second blade exit end 232.

The width W1 of the second blade 23 gradually decreases from the second blade entry end 231 to the second blade exit end 232. The thickness T1 of each of the second blades 23 gradually decreases from the second blade entry end 231 to the second blade exit end 232.

Please refer to FIGS. 6, 7 and 7A. A plurality of through grooves 25 are equidistantly arranged around and pass through the outer side wall 26, and each through groove 25 extends in an arc from the second open end 22 toward the second closed end 21. Each through groove 25 has a first end 251 and a second end 252 opposite to each other. The first end 251 is located at the second open end 22.

As shown in FIG. 7A, the projection position P251 of the first end 251 of the through groove 25 is misaligned with the projection position P252 of the second end 252. The extension direction F1 of the line connecting the first end 251 and the second end 252 has a second included angle θ2 greater than 0 degrees and less than 90 degrees with the second open end 22.

As shown in FIG. 6, the second space S20 and the first space S10 are connected by each through groove 25.

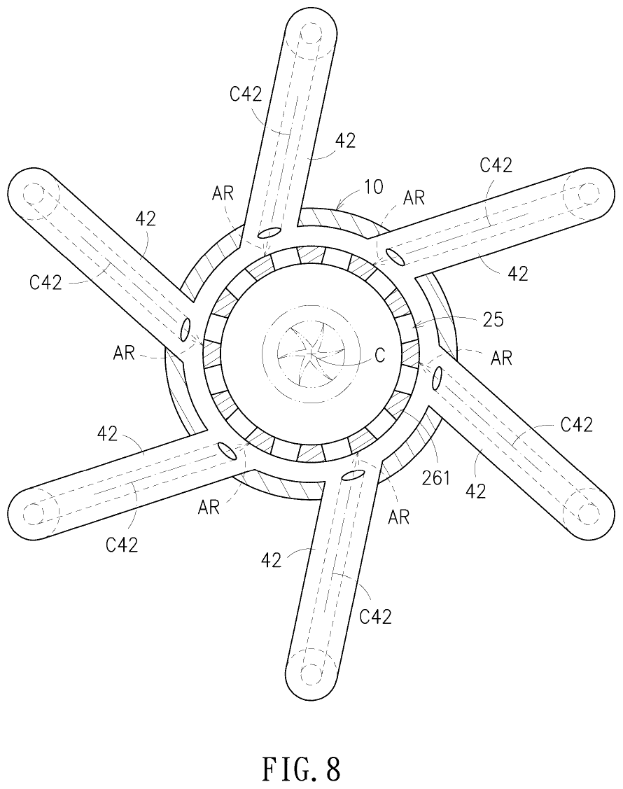

Please refer to FIGS. 7 and 8. In addition to the axis center C42 of each second tube 42 misaligned with the central axis C as shown in FIG. 3, the axis center C42 of each second tube 42 does not pass through each through groove 25 as shown in FIG. 8. After the gas AR flows into the first cavity 10 from the second tube 42, it will hit the fence portion 261 of the outer side wall 26 between two adjacent through grooves 25 so as to generate turbulence. Therefore, it can be avoided that the gas AR flows into the first cavity 10 from the second tube 42 before it has been mixed with the liquid in the first cavity 10 and flows directly into the second cavity 20 through the through groove 25.

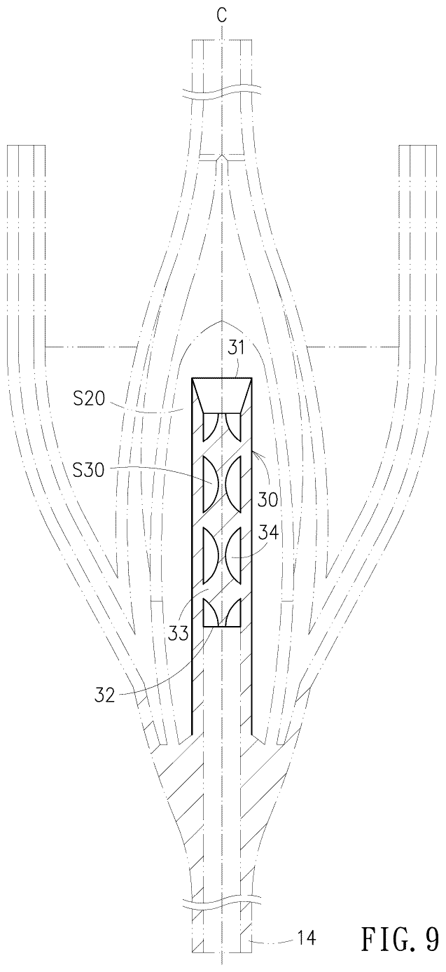

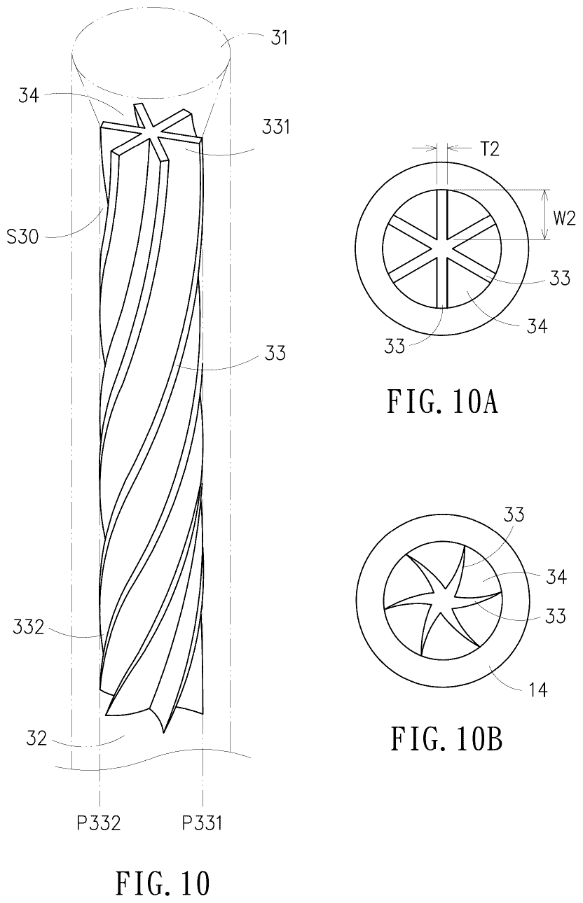

Please refer to FIGS. 9, 10, 10A and 10B. The third cavity 30 is a hollow circular pipe. The third cavity 30 is parallel to the central axis C and has a third entry end 31 and a third exit end 32 that are opposite and connected to each other. The third cavity 30 is disposed within the second cavity 20 and does not contact the second cavity 20. The gas-liquid outlet pipe 14 is connected to the third exit end 32.

The third cavity 30 further includes a third space S30 and a plurality of third blades 33. In this embodiment, the third blades 33 are equidistantly arranged around the central axis C and disposed in the third space S30. A third curved channel 34 is formed between two adjacent third blades 33.

The third blade 33 extends in an arc from the third entry end 31 toward the third exit end 32. The end of the third blade 33 near the third entry end 31 is the third blade entry end 331, and the end of the third blade 33 near the third exit end 32 is the third blade exit end 332. When the central axis C is set perpendicular to the horizontal plane as shown in FIG. 10, the projection position P331 of the third blade entry end 331 of the third blade 33 is misaligned with the projection position P332 of the third blade exit end 332.

The width W2 of the third blade 33 is the same from the third blade entry end 331 to the third blade exit end 332. The thickness T2 of each third blade 33 gradually decreases from the third blade entry end 331 to the third blade exit end 332.

The second space S20 and the third space S30 are connected by each third curved channel 34, and the third exit end 32 is connected to the external space by the gas-liquid outlet pipe 14.

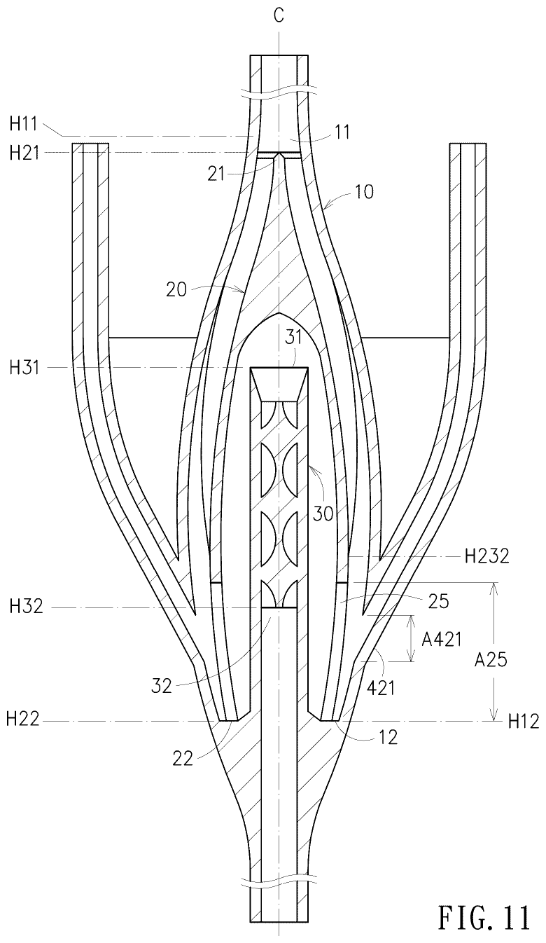

Please refer to FIG. 11. When the central axis C is set perpendicular to the horizontal plane as shown in FIG. 11, and the horizontal height H11 of the first open end 11 of the first cavity 10 is higher than the horizontal height H12 of the first closed end 12, the horizontal height H21 of the second closed end 21 of the second cavity 20 is higher than the horizontal height H22 of the second open end 22, and the horizontal height H31 of the third entry end 31 of the third cavity 30 is higher than the horizontal height H32 of the third exit end 32.

Furthermore, the projection range A421 of the inner diameter of the gas outlet end 421 parallel to the horizontal plane is located within the projection range A25 of the through groove 25 parallel to the horizontal plane.

In addition, the horizontal height H232 of the second blade exit end 232 is located outside the projection range A25 of the through groove 25 parallel to the horizontal plane.

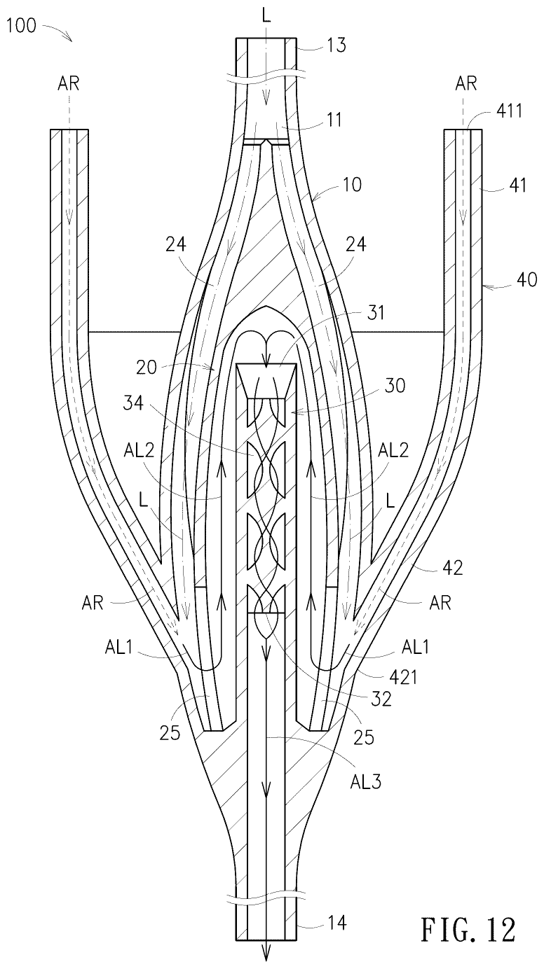

Please refer to FIG. 12 to illustrate the process of mixing gas and liquid in the gas-liquid reaction device 100 provided by the present disclosure. The liquid L enters the first open end 11 through the liquid inlet pipe 13, then enters the first cavity 10 and flows into each of the second curved channel 24. Gas AR enters the first tube 41 through the gas inlet end 411 of each gas inlet pipe 40, then passes through the connecting tube 43 and enters the first cavity 10 through the gas outlet end 421 of the second tube 42. Gas AR and liquid L are mixed in the first space S10 of the first cavity 10 in the first stage to form the first-stage mixed gas liquid AL1.

Afterwards, the first-stage mixed gas liquid AL1 flows into the second space S20 of the second cavity 20 through each of the through grooves 25 of the second cavity 20, and undergoes a second-stage mixing in the second cavity 20 to form the second-stage mixed gas liquid AL2.

Then, the second-stage mixed gas liquid AL2 flows into the third space S30 of the third cavity 30 from the third entry end 31 of the third cavity 30 and into each third curved channel 34 for third-stage mixing to form the third-stage mixed gas liquid AL3.

Afterwards, the third-stage mixed gas liquid AL3 flows out of the third cavity 30 from the third exit end 32 and then flows out to the external space through the gas-liquid outlet pipe 14 for subsequent processes.

Based on the foregoing, the gas-liquid reaction device of the present disclosure has a composite cavity structure that can accelerate and prolong gas-liquid mixing, causing turbulence, eddies, and jetting effects as the gas and liquid flow through each cavity, thereby ensuring that the gas and the reactants in the solution are fully and uniformly mixed in the turbulent flow channel. The gas-liquid reaction device of the present disclosure is driven by fluid kinetic energy without the need for a stirring motor or any tanks to hold the fluid. This not only significantly saves space required for processing and considerable reactor construction costs and motor power, but also greatly increases production capacity due to continues operation.

Persons skilled in the art can understand that the gas-liquid reaction device of the present disclosure is not limited to the first cavity, second cavity, and third cavity of the embodiment. A fourth cavity, fifth cavity, or more cavities may be provided as needed. The multi-layered encapsulation structure extends the flow path of the gas and liquid, and the arrangement of blades accelerates the flow rate of the gas and liquid.

The above content is only a specific implementation method of the present disclosure. Persons having ordinary knowledge in the relevant field can clearly understand that for the convenience and brevity of description, the specific working processes of the systems, modules and units described above can refer to the corresponding processes in the aforementioned method embodiment and will not be repeated here. It should be understood that the protection scope of the present disclosure is not limited thereto. Any person with ordinary knowledge in the technical field can easily conceive of various equivalent modifications or replacements within the technical scope of the present disclosure, and these modifications or replacements should be included in the protection scope of the present disclosure.

What is claimed is:

1. A gas-liquid reaction device, comprising:
a first cavity, parallel to a central axis and having a first open end and a first closed end opposite to each other, and further having a first space, wherein the first space is connected to the first open end;
a second cavity, disposed within the first cavity and not in contact with the first cavity, wherein the second cavity has an opposite second closed end, a second open end, a plurality of second blades, a second space, an outer side wall, and a plurality of through grooves, each of the second blades is disposed on an outer side wall of the second cavity respectively and extends in an arc from the second closed end toward the second open end, an end of each of the second blades near the second closed end is a second blade entry end, an end of each of the second blades near the second open end is a second blade exit end, a second curved channel is formed between two adjacent second blades, each second curved channel is connected to the first open end, each of the through grooves is disposed through the outer side wall and extends from the second open end toward the second closed end and has a first end and a second end opposite to each other, the first end is located at the second open end, an extension direction of a line connecting the first end and the second end has a second included angle greater than 0 degrees and less than 90 degrees with the second open end, and the second space and the first space are connected by each of the through grooves;
a third cavity, disposed within the second cavity and not in contact with the second cavity, wherein the third cavity has a third entry end and a third exit end-end that are opposite to and connected to each other, and a third space, the third space is provided with a plurality of third blades, each of the third blades extends in an arc from the third entry end toward the third exit end, an end of each third blade near the third entry end is a third blade entry end, and an end of each third blade near the third exit end is a third blade exit end, a third curved channel is formed between two adjacent third blades, the second space and the third space are connected by each of the third curved channels; and
at least one gas inlet pipes, connected to the first cavity, wherein each gas inlet pipe is composed of a first tube, a connecting tube and a second tube that are connected to each other, an end of the first tube connected to the connecting tube is a gas inlet end, and an end of the second tube connected to the connecting tube is a gas outlet end, and the gas outlet end is connected to the first cavity so that each gas inlet pipe is connected to the first cavity;
wherein when the central axis is perpendicular to a horizontal plane and a horizontal height of the first open end is higher than a horizontal height of the first closed end, a horizontal height of the second closed end is higher than a horizontal height of the second open end, a horizontal height of the third inlet end is higher than a horizontal height of the third outlet end, a projection position of the first end of each of the through grooves is misaligned with a projection position of the second end, and a projection range of the gas outlet end parallel to the horizontal plane is located within a projection range of each through groove parallel to the horizontal plane.

2. The gas-liquid reaction device according to claim 1, wherein an axis center of each of the second tubes is misaligned with the central axis and does not directly pass through each of the through grooves.

3. The gas-liquid reaction device according to claim 1, wherein when the central axis is perpendicular to the horizontal plane, projection positions of the second blade entry end and the second blade outlet end are misaligned.

4. The gas-liquid reaction device according to claim 1, wherein a width of each of the second blades gradually decreases from the second blade entry end to the second blade outlet end.

5. The gas-liquid reaction device according to claim 1, wherein a thickness of each of the second blades gradually decreases from the second blade entry end to the second blade outlet end.

6. The gas-liquid reaction device according to claim 1, wherein when the central axis is perpendicular to a horizontal plane, a horizontal height of the second blade outlet end is outside a projection range of the through groove parallel to a horizontal plane.

7. The gas-liquid reaction device according to claim 1, wherein when the central axis is perpendicular to a horizontal plane, projection positions of the third blade entry end and the third blade outlet end of each third blade are misaligned.

8. The gas-liquid reaction device according to claim 1, wherein a width of each of the third blades is equal from the third blade entry end to the third blade outlet end.

9. The gas-liquid reaction device according to claim 1, wherein a thickness of each of the third blades gradually decreases from the third blade entry end to the third blade outlet end.

10. The gas-liquid reaction device according to claim 1, wherein the connecting tube is curved and bent, an axis center of the first tube is parallel to the central axis, and an axis center of the second tube has a first included angle greater than 0 degrees and less than 90 degrees with the central axis.

11. The gas-liquid reaction device according to claim 1, wherein the first cavity extends parallel to the central axis to form a cylindrical liquid inlet pipe and a cylindrical gas-liquid outlet pipe relatively, the liquid inlet pipe is connected to the first open end, and the gas-liquid outlet pipe is connected to the third exit end.

12. The gas-liquid reaction device according to claim 1, wherein each of the gas inlet pipes is interconnected to the first cavity by providing a connecting piece therebetween.

13. The gas-liquid reaction device according to claim 1, wherein an inner diameter of the first cavity gradually decreases toward the first open end and the first closed end respectively, so that the first space of the first cavity is a spindle-shaped internal space.

14. The gas-liquid reaction device according to claim 1, wherein an inner diameter of the second cavity gradually narrows toward the second open end and the second closed end respectively, so that the second space of the second cavity is an elongated elliptical internal space.

15. The gas-liquid reaction device according to claim 1, wherein a plurality of gas inlet pipes are arranged, the plurality of gas inlet pipes are equidistantly around the first cavity and connected to the first cavity.

16. The gas-liquid reaction device according to claim 1, wherein the plurality of second blades are arranged equidistantly around the outer side wall.

17. The gas-liquid reaction device according to claim 1, wherein the plurality of through grooves are arranged equidistantly around and pass through the outer side wall.

18. The gas-liquid reaction device according to claim 1, wherein the third cavity is a hollow circular pipe, and the plurality of third blades are arranged equidistantly around the central axis and disposed in the third space of the third cavity.

19. The gas-liquid reaction device according to claim 1, wherein the central axis passes through a center of the first open end and a center of the first closed end, a center of the second closed end and a center of the second open end, and a center of the third entry end and a center of the third exit end.
